(19) United States
(12) Patent Application Publication
(10) Pub. No.: US 2005/0152364 A1
(43) Pub. Date: Jul. 14, 2005

(54) Traffic control system of P2P network

(75) Inventors: Atsushi Tagami, Saitama (JP); Teruyuki Hasegawa, Saitama (JP); Toru Hasegawa, Saitama (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KDDI CORPORATION, Tokyo (JP)

(21) Appl. No.: 11/030,190

(22) Filed: Jan. 7, 2005

(30) Foreign Application Priority Data
Jan. 14, 2004 (JP) 2004-6917

(51) Int. Cl. H04L 12/56

(52) U.S. Cl. 370/389

(57) ABSTRACT

This present invention provides a traffic control system which adapts a P2P traffic to the circuit capacity and topology of a physical network. In a traffic control portion, a correspondent node identifying portion monitors the header of a packet exchanged by each P2P traffic and identifies the attribute of a correspondent node. A monitoring object extracting portion extracts a P2P connection based on the identification result. A traffic amount measuring portion obtains the total amount of each P2P traffic which is a monitoring object. A connection selecting portion selects a connection which should be shut down based on the total traffic amount. A filter portion shuts down the shut-down object connection selected by the connection selecting portion of the traffic monitoring portion.

### BACKGROUND OF THE INVENTION

1. Field of the Invention

The present invention relates to a traffic control system for P2P network and more particularly to a traffic control system for adapting the P2P traffic to the circuit capacity and topology of physical network.

2. Description of the Related Art

As a new network model in Internet, peer-to-peer (P2P) network has attracted public attention. In the P2P network, respective terminals exchange information equally in a different way from sever/client model type computer network constituted of a server for accumulating information and terminal computers (client) for receiving information from this server, which has been seen conventionally. General P2P network has been disclosed in a patent document 1 and the like.

In a logical network constituted of the P2P, a node located far from a physical network may be though to be located at a near position in a logical network depending on a case, because the circuit capacity and topology of the physical network are not considered. Because a file is transmitted from a node located at such a far position in this case, wasteful load is generated in the traffic. As regards such a technical problem, a non-patent document 1 has considered influences upon the network of the P2P traffic.
Patent document: Japanese Patent Application Laid-Open No.2002-312327.
Non-patent document: “Actual situation and subjects of P2P file sharing”, Singaku-giho, CQ2003-40 (2003-07)

Although under conventional technology, influences upon the network of the P2P traffic have been considered and its actual situations have been clarified gradually, no specific method for adapting the P2P traffic to the circuit capacity and topology of the physical network has been proposed conventionally.

### SUMMARY OF THE INVENTION

An object of the present invention is to provide a traffic control system which adapts the P2P traffic to the circuit capacity and topology of the physical network and the feature of the invention exits in that following means are taken in the traffic control system of the P2P network.

(1) The feature of the invention exists in comprising:
a dummy node for executing at least one P2P application; a monitor device which monitors a connection communicating with each application of the dummy node and selects a connection which is a shut-down object; and a filter device for shutting down connections selected by the monitor device.

(2) The feature of the invention exists in comprising:
a means for identifying the attribute of a correspondent node of each connection; and a means for extracting the traffic of a monitoring object based on the attribute of said correspondent node.

(3) The feature of the invention exists in comprising:
the IP address and port number of said correspondent node are identified as the attributes of the correspondent node.

(4) The feature of the invention exists in comprising:
the monitor device accumulates the traffic amounts of each connection which is a monitoring object so as to select connections exceeding a predetermined reference traffic amount and notifies said filter device.

(5) The feature of the invention exists in comprising:
the monitor device measures a duration time of each connection which is a monitoring object so as to select a connection exceeding a predetermined reference duration time and notifies said filter device.

The invention achieves following effects.

(1) Because a dummy node which introduces P2P traffics by executing each P2P application is provided and connections established in application level between this dummy node and correspondent modes are monitored, selective monitoring of the P2P connection can be executed easily.

(2) Because the attribute of each correspondent node of the P2P connections are specified and only connections having a predetermined attribute are taken as monitoring objects, if a connection established between node accommodated in, for example, an external network is taken as a monitoring object, an intentional control for adapting the configuration of the P2P network to the topology of a physical network is possible.

(3) Because connections to be shut down are selected based on a measurable parameter, for example, its traffic amount or a duration time, enormous amount of connections can be selected with a simple structure.

### BRIEF DESCRIPTION OF THE DRAWINGS

FIG. 1 is a block diagram showing the configuration of a network which the present invention is applied to;

FIG. 2 is a functional block diagram of a traffic control system of the present invention;

FIG. 3 is a flow chart showing the operation of the traffic control system; and

FIG. 4 is a diagram showing an example of a traffic monitoring system.

### DETAILED DESCRIPTION OF THE PREFERRED EMBODIMENTS

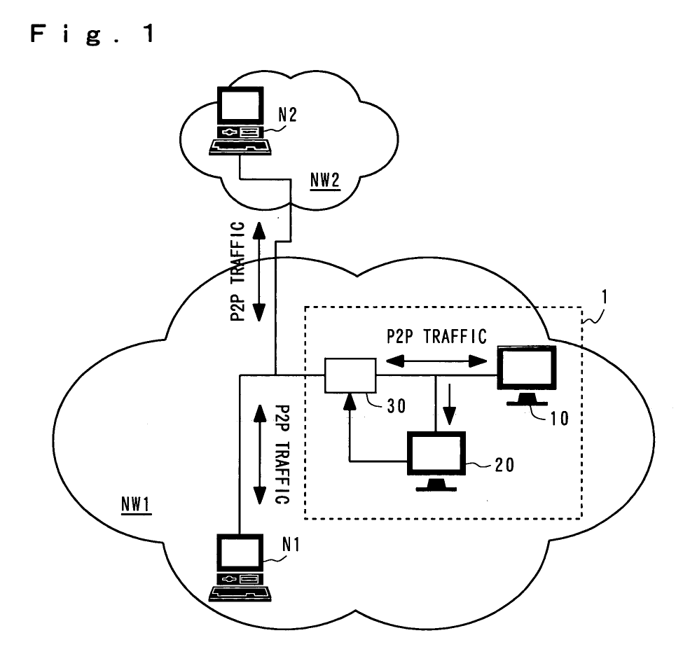

FIG. 1 is a block diagram of the P2P network which the present invention is applied to and a traffic control system 1 of the invention is disposed in a first network NW1 controlled by a first ISP.

The traffic control system 1 includes a dummy node 10 which introduces P2P traffic by functioning as a normal P2P node, a monitor device 20 which monitors each P2P traffic in which this dummy node 10 is regarded as a peer and selects P2P connections which are shut-down objects and a filter device 30 which shuts down P2P connections selected by this monitor device 20.

The aforementioned dummy node 10 behaves as a P2P node by executing at least one P2P application so as to establish P2P connections in a relationship with not only a user node N1 accommodated in the first network NW1 but also the non-user node N2 accommodated in the second network NW2 controlled by the second ISP different from the first ISP.

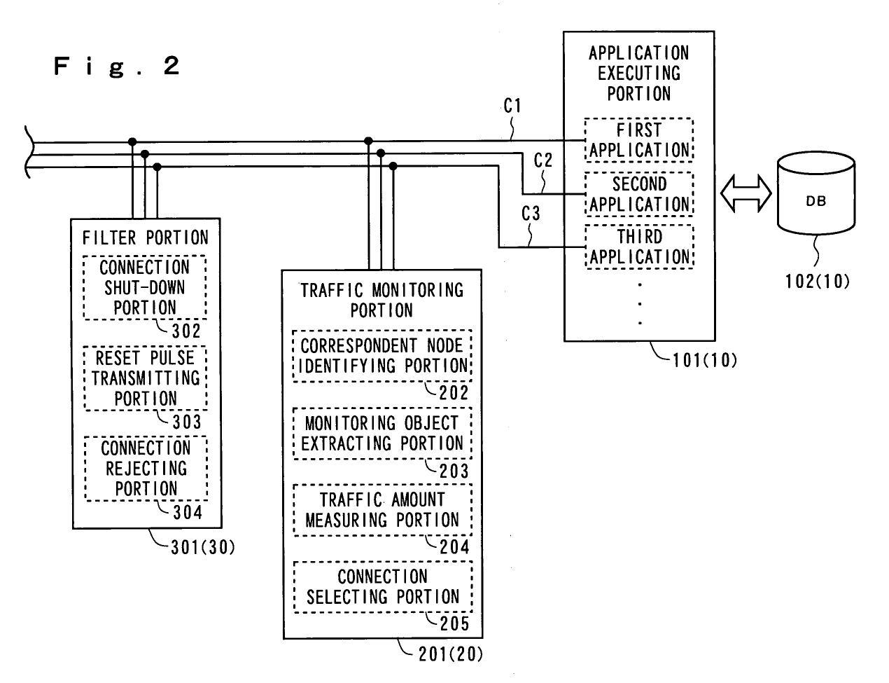

FIG. 2 is a functional block diagram of the traffic control system 1.

An application executing portion 101 and a database (DB) 102 are installed on the dummy node 10. At least one P2 P application (first application, second application, third application . . . ) is executed in the application executing portion 101, so that P2P connections C1, C2, C3 . . . are established in a relationship with correspondent nodes including the non-user node N2 accommodated in the second network NW2.

A large memory capacity exceeding the memory capacity of normal P2P node constituted of a personal computer is secured in the database 102, which stores files distributed form neighboring nodes, files relayed when an action as cache is specified by a neighboring node.

The traffic monitoring portion 201 is installed on the monitoring device 20 and includes a correspondent node identifying portion 202, a monitoring object extracting portion 203, a traffic amount measuring portion 204 and a connection selecting portion 205. The correspondent node identifying portion 202 monitors the header of a packet exchanged by each P2P traffic and extracts the IP address and port number of a correspondent node. Then, the attribute of a correspondent node is identified based on the extracted IP address and port number. The monitoring object extracting portion 203 extracts P2P connections of monitoring object from a number of P2P connections in which the dummy node 10 is regarded as a peer, based on the identification result.

According to this embodiment, the types of an accommodation network and application are obtained as the attribute of the aforementioned correspondent node. P2P connections, which are established by each P2P application and accommodated in a network controlled by an ISP in which correspondent nodes are different from the dummy node 10, are extracted as monitoring objects.

The traffic amount measuring portion 204 obtains the total amount of respective P2P traffics of monitoring objects. The connection selecting portion 205 selects connections which should be shut down based on the total traffic amount and notifies the filter portion 301 of a selection result.

The filter portion 301 is installed on the filter device 30 and includes a connection shut-down portion 302, a reset pulse transmitting portion 303 and a connection rejecting portion 304. The connection shut-down portion 302 shuts down connections of shut-down object selected by the connection selecting portion 205 of the traffic monitoring portion 201. Regarding the shut-down connection, the reset pulse transmitting portion 303 transmits a reset pulse to both the dummy node 10 and the correspondent node. The connection rejecting portion 304 rejects additional connection requests from correspondent nodes of the shut-down connection for a predetermined time.

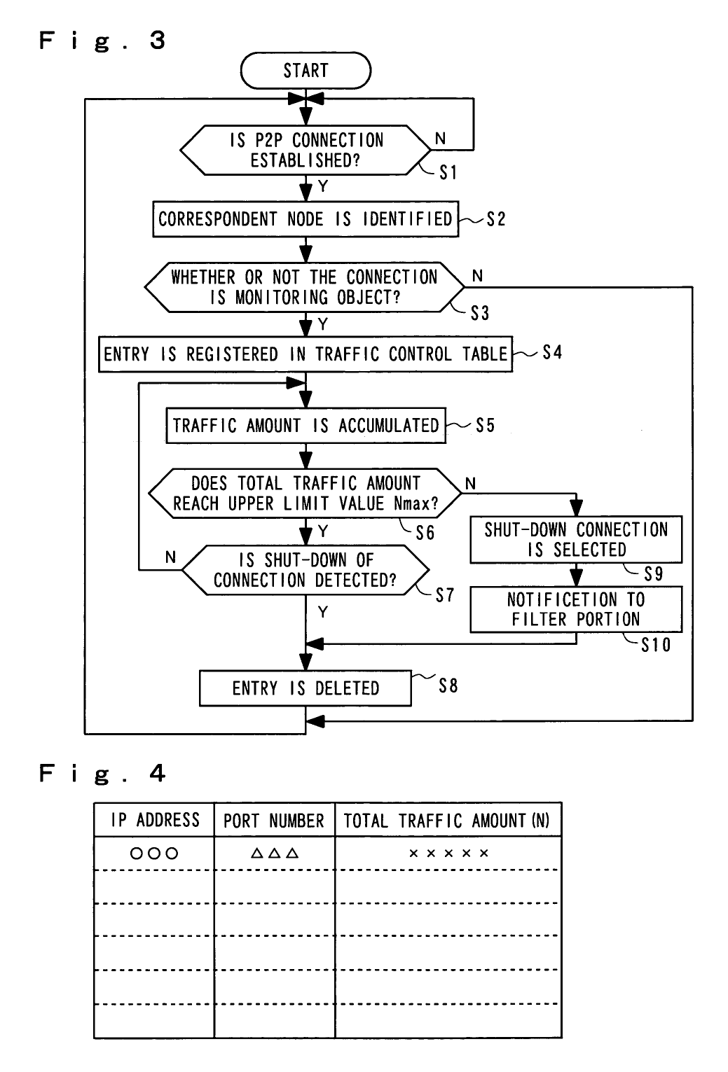

The operation of the traffic monitoring portion 201 will be described with reference to the flow chart of FIG. 3.

If it is detected that a P2P connection is established between the dummy node 10 and other node in step S1, the IP address and port number of a correspondent node are identified by the correspondent node identifying portion 202 in step S2. Whether or not the connection is a monitoring object is determined based on the identification result in step S3.

According to this embodiment, whether a correspondent node is a user node N1 accommodated in the first network NM1 or a non-user node N2 accommodated in the second network NM2 is determined by the correspondent node identifying portion 202 and its application is recognized based on a port number and finally, whether or not an established connection is a P2P connection is determined. If it is determined that the correspondent node is non-user node N2 and that the established connection is a P2P connection, the given connection is extracted as a monitoring object by the monitoring object extracting portion 203. An entry about that connection is registered in a traffic control table whose example is shown in FIG. 4 in step S4.

In step S5, the data amount of a packet flowing through the P2P connection is obtained by the traffic amount measuring portion 204 and accumulated by the traffic monitoring table. In step S6, the total traffic N is compared with a predetermined upper limit Nmax by the connection selecting portion 205. As long as the total traffic amount N does not reach the upper limit value Nmax while a shut-down of the connection is not detected in step S7, the connection is maintained and the procedure returns to the step S5, in which the accumulation of the traffic and comparison of the total traffic N with the upper limit value Nmax are repeated.

If the total traffic amount N reaches the upper limit value Nmax without shut-down of the P2P connection, the procedure proceeds to step S9. In step S9, the P2P connection is selected as a shut-down object. In step S10, this selected P2P connection is notified to the filter portion 301. In step S8, the entry of the P2P connection is deleted from the traffic monitoring table.

If the filter portion 301 is notified of a P2P connection which is a shut-down object, it shuts down that connection at the connection shut-down portion 302 and a reset pulse is transmitted from the reset pulse transmitting portion 303 to both the dummy node 10 and a correspondent node N2 as regards the shut-down P2P connection. The connection rejecting portion 304 retains the IP address of the correspondent node N2 of the shut-down connection as a black list in a predetermined period so as to reject a connection request from the correspondent node N2.

Because according to this embodiment a dummy node having a large memory capacity is disposed and made usable as a cache, the P2P connection can be concentrated to the dummy node. Thus, if the circuit capacity of a path to the dummy node 10 is increased selectively, not only influences of the P2P connection upon the physical network can be suppressed but also connection of a user node to an external network (second network NW2) can be reduced.

Further because the frequency of shutting down a connection from a non-user node to user node increases so as to reduce connections across different networks, construction of P2P network adaptable for the topology of a physical network is enabled.

Although according to the above-described embodiment, the traffic amount of each P2P connection is obtained and P2P connections of which the total traffic amount N exceeds the upper limit value Nmax are shut down, the present invention is not restricted to this example, but it is permissible to so construct that the connection time of each P2P connection is monitored and P2P connections in which the connection time exceeds the upper limit value are shut down.

1. A traffic control system, for controlling the traffic of P2P network, comprising:
a dummy node for executing at least one P2P application;
a monitor device which monitors a connection communicating with each application of said dummy node and selects a connection which is a shut-down object; and
a filter device for shutting down connections selected by said monitor device.

2. The traffic control system of P2P network according to claim 1 wherein said monitor device comprises:
a means for identifying the attribute of a correspondent node of each connection; and
a means for extracting the traffic of a monitoring object based on the attribute of said correspondent node.

3. The traffic control system of P2P network according to claim 2 wherein the IP address and port number of said correspondent node are identified as the attributes of the correspondent node.

4. The traffic control system of P2P network according to claim 1 wherein said monitor device accumulates the traffic amounts of each connection which is a monitoring object so as to select connections exceeding a predetermined reference traffic amount and notifies said filter device.

5. The traffic control system of P2P network according to claim 1 wherein said monitor device measures a duration time of each connection which is a monitoring object so as to select connections exceeding a predetermined reference duration time and notifies said filter device.

6. The traffic control system of P2P network according to claim 2 wherein said monitor device accumulates the traffic amounts of each connection which is a monitoring object so as to select connections exceeding a predetermined reference traffic amount and notifies said filter device.

7. The traffic control system of P2P network according to claim 3 wherein said monitor device accumulates the traffic amounts of each connection which is a monitoring object so as to select connections exceeding a predetermined reference traffic amount and notifies said filter device.

8. The traffic control system of P2P network according to claim 2 wherein said monitor device measures a duration time of each connection which is a monitoring object so as to select connections exceeding a predetermined reference duration time and notifies said filter device.

9. The traffic control system of P2P network according to claim 3 wherein said monitor device measures a duration time of each connection which is a monitoring object so as to select connections exceeding a predetermined reference duration time and notifies said filter device.
